(19) United States
(12) Patent Application Publication
(10) Pub. No.: US 2012/0037751 A1
(43) Pub. Date: Feb. 16, 2012

(54) SUPERSONIC FLYING WING

(75) Inventor: GeCheng Zha, Cutler Bay, FL (US)

(73) Assignee: UNIVERSITY OF MIAMI, Miami, FL (US)

(21) Appl. No.: 13/263,477

(22) PCT Filed: Apr. 26, 2010
(86) PCT No.: PCT/US2010/032350

§ 371 Date: Oct. 7, 2011

Related U.S. Application Data
(60) Provisional application No. 61/172,929, filed on Apr. 27, 2009.

(51) Int. Cl. B64B 1/36

(52) U.S. Cl. 244/52

(57) ABSTRACT

A bidirectional flying wing maximizes efficiency and reduces sonic boom during supersonic flight. The flying wing has bilateral symmetry across two perpendicular planes and a substantially isentropic compression bottom surface that minimizes the shock wave projected downward during flight. The flying wing may be rotated to provide a high aspect ratio and a low sweep angle during subsonic flight. The flying wing may be rotated to provide a low aspect ratio and a high sweep angle during supersonic flight.

### FIELD OF THE INVENTION

The present invention relates to a method and system for a multidirectional flying wing having a reduced sonic boom and improved subsonic and supersonic aerodynamics efficiency.

### BACKGROUND OF THE INVENTION

Supersonic commercial flight has always been a great interest of aircraft design engineers, scientists, and business professionals due to the potential to reduce inter-continental travel time. Currently, a trip from Chicago to Hong Kong on commercial flights today takes approximately 14 hours. A supersonic transport (SST) may be able to make a similar journey in about 5 hours. This significantly shorter flight time makes SSTs very attractive. However, building a practical SST presents several challenges.

First, an SST generates a sonic boom. As it travels through the air, an SST generates a shock wave in the air. This shock wave expands out as a pressure wave that even at great distances may be as strong as 3 pounds per square foot (psf.) or more. The resulting sonic boom is very loud, and may even be strong enough to break glass or other brittle materials. The Aérospatiale-BAC Concorde®, the only SST ever to be used commercially use, was forbidden to fly at supersonic speeds over land due to the undesirable and problematic sonic boom it generated. Therefore, a practical SST must have a weak sonic boom.

Second, all supersonic aircraft experience significant wave drag caused by air traveling at supersonic speeds over the aircraft. Wave drag may be four or more times as strong as drag experienced at subsonic speeds. Wave drag significantly decreases the efficiency of the aircraft and vastly increases fuel consumption, strain on the aircraft and operating costs. Therefore, a practical SST must have a reduced wave drag.

Third, aircraft designed to fly at supersonic speeds typically perform poorly at slower, subsonic speeds. At subsonic flying speeds, such as during take-off and landing, aircraft having a high aspect ratio, low sweep angle and blunt leading edge on the airfoil perform better. The aspect ratio is the ratio of the wingspan to the wing chord, i.e. the width of the wing. The wing sweep angle is the angle at which the wings deviate from perpendicular to the direction of flight. The leading edge is the front of the wing. Aircraft designed for subsonic flight typically have a relatively narrow wings protruding directly at or close to perpendicular from the direction of flight and have a blunt leading edge.

Aircraft at supersonic speeds perform better with a lower aspect ratio (shorter wingspan), a relatively high sweep angle and a sharp leading edge on the airfoil. As a result, supersonic aircraft tend to perform poorly at subsonic speeds and are more difficult to control during take-off and landing.

Several attempts have been made to overcome these difficulties. For example, the Grumman F-14 Tomcat® incorporates wings having a variable sweep angle, allowing it to adjust the craft's aspect ratio and wing sweep. However, variable sweep wings require the inclusion of the sweep angle varying mechanisms, substantially increasing the weight of the plane.

Others have modified the nose of a plane to reduce the sonic boom. Specifically, the nose is made very blunt and rounded to distribute the shock wave. Modification of the shape of the lower portion of the front of the fuselage decreases the sonic boom experienced on the ground. However, the reduction in sonic boom is insufficient to allow safe use of supersonic aircraft over populated areas.

The Gulfstream Quiet Spike® has also been developed to decrease the sonic boom. This concept employs a spike added to the front of a fuselage. The spike increases in diameter in a stepwise manner, thereby creating several weak shock waves. This mechanism creates more, smaller shock waves. However, the spike usually extends at least a third of the length of the aircraft, making it unstable and impractical, and does not reduce the sonic boom to an acceptably low level.

For years NASA® and others experimented with an oblique wing design. The oblique wing consisted of a wing mounted to the fuselage in a pivotable fashion. As the plane increased in speed, the wing pivoted. This design provides decreased wave drag and improved aerodynamic performance. However, the asymmetric wing sweep, forward on one side of the plane and backward on the other, couples pitch with roll and decreases the stability of the craft. Naturally occurring flight designs, such as birds, insects and even dinosaurs, have symmetric planforms (the shape of a flying craft as viewed from directly above). Thus, millions of years of evolution also argue against asymmetric planforms.

It is therefore desirable to provide a supersonic transport aircraft. It is also desirable to provide a supersonic transport aircraft having reduced sonic boom, wave drag, and that operates efficiently at subsonic speeds.

### SUMMARY OF THE INVENTION

The present invention advantageously provides an aircraft comprising a lifting body and a propulsion element. The lifting body will rotate about the propulsion system. The propulsion system will stay in the flight direction to provide the required thrust and not rotate.

In another aspect the invention provides a supersonic bidirectional flying wing comprising a lifting body having bilateral symmetry across a longitudinal plane and bilateral symmetry across a transverse plane, a substantially isentropic compression bottom surface, an upper surface, a propulsion element rotatably attached to the upper surface, one or more engines mounted on the propulsion element, a front longitudinal tip and a back longitudinal tip, each pivotably coupled to the lifting body such that they may pivot to approximately perpendicular to the isentropic compression bottom surface during flight in the transverse direction, wherein the lifting body has a sweep angle of at least 40 degrees and an aspect ratio of less than 5 during flight parallel to a longitudinal axis and wherein the lifting body has a sweep angle less than 50 degrees and an aspect ratio of at least 3 during flight parallel to a transverse axis.

In another aspect the invention provides a method for subsonic and supersonic flight with reduced sonic boom generation comprising providing a lifting body having a substantially isentropic compression bottom surface, wherein the lifting body has a high aspect ratio and low sweep angle in a transverse direction and has a low aspect ratio and a high sweep angle in a longitudinal direction, propelling the lifting body in the transverse direction during subsonic flight and propelling the lifting body in the longitudinal direction during supersonic flight.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a supersonic bidirectional flying wing constructed in accordance with the principles of the present invention;

FIG. 2 is the planform of the supersonic bidirectional flying wing shown in FIG. 1;

FIG. 3 is an alternative planform of a supersonic bidirectional flying wing constructed in accordance with the principles of the present invention;

FIG. 4 is a perspective view of an alternative supersonic bidirectional flying wing constructed in accordance with the principles of the present invention;

FIG. 5 is the longitudinal cross-section of the supersonic airfoil of the supersonic bidirectional flying wing shown in FIG. 1;

FIG. 6 is the transverse cross-section of the subsonic airfoil of the supersonic bidirectional flying wing shown in FIG. 1;

FIG. 7 is a diagram of a slat and airfoil used in accordance with the principles of the present invention;

FIG. 8 is a diagram of a radial airflow ejector and airfoil used in accordance with the principles of the present invention;

FIG. 9 is a diagram of a radial airflow and a unidirectional airflow;

### DETAILED DESCRIPTION OF THE INVENTION

The present invention provides for a supersonic aircraft that is capable of flying at subsonic speeds in one direction and then rotating 90° to fly at supersonic speeds in another direction, thereby reducing wave drag and increasing efficiency. The invention includes a substantially isentropic compression lower surface that results in a weak or no downward shock wave and a reduced sonic boom.

The aircraft rotation will be controlled by split flaps (similar to that of a B2 bomber) on the wings, which will split and open on one side of the flying wing and create the yaw moment. There will be a lock/unlock mechanism between the flying body and the propulsion system. When it is unlocked between the flying body and the engines, the yaw moment will rotate the flying body and the propulsion system will remain in the flight direction. When the flying body and the engines are locked, the yaw moment will rotate the whole system as the yaw control. The pitch will be controlled by the flaps or the ailerons on the two sides of the flying axis with both sides deflecting in the same direction. The rolling will be also controlled by the flaps or ailerons with both sides deflecting in the opposite direction.

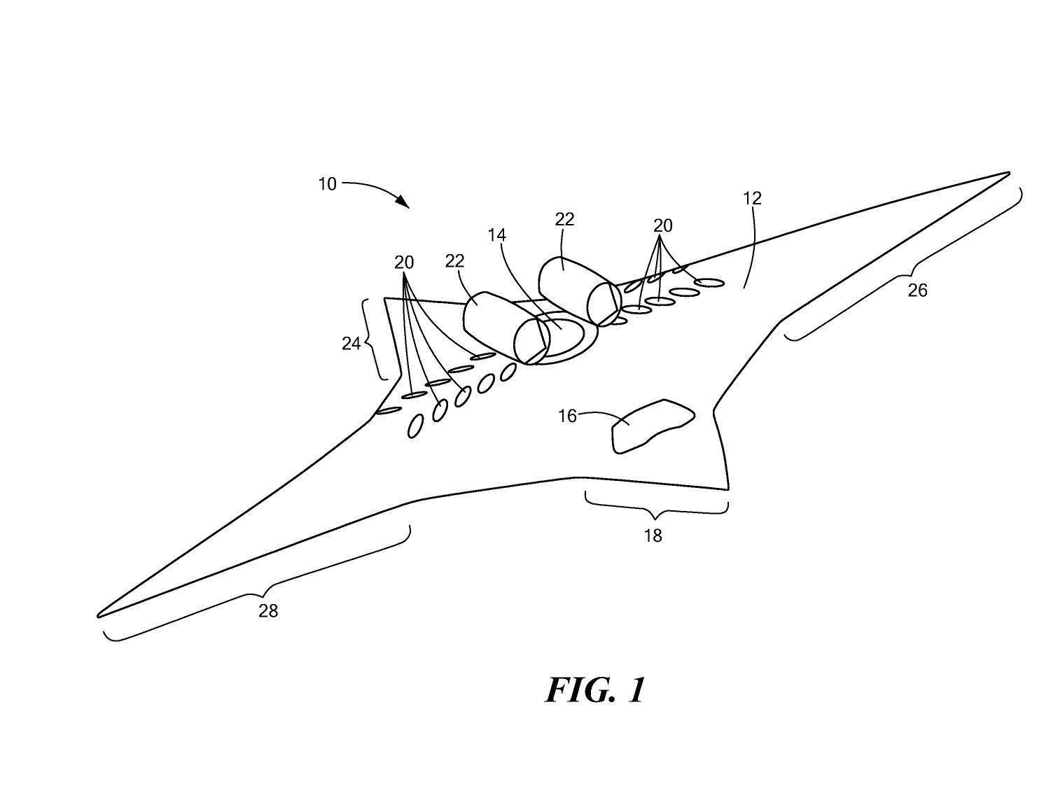

Referring now to the drawing figures in which like reference designators refer to like elements, there is shown in FIG. 1 an embodiment of a supersonic bidirectional flying wing constructed in accordance with principles of the present invention and generally designated as “10.” The flying wing 10 is shown in its subsonic configuration, flying in a transverse direction. The flying wing 10 may have a lifting body 12 and a propulsion element 14. The entire lifting body 12 may act as a wing to provide lift to the flying wing 10. The flying wing 10 optionally may include one or more internal compartments such as a passenger compartment, a cockpit and a fuel tank. A windshield 16 may be located in the front transverse region 18, where a cockpit may be housed. Similarly, the windows 20 may provide a view to persons in a passenger compartment. The flying wing 10 may also include additional compartments for storing cargo or other materials.

The propulsion element 14 may be rotatably attached to the lifting body 12 and may comprise a platform and one or more, for example two, jet engines 22. The propulsion element 14 may optionally have vertical stabilizers. When the flying wing 10 is flown at subsonic speeds, the propulsion element 14 may be positioned at a yaw angle such that the engines 22 provide thrust in a direction parallel to the transverse axis of the lifting body 12 such that the front transverse region 18 may face the direction of travel and the back transverse region 24 may be in the center of the trailing edge of the lifting body 12. The lifting body 12 may also be rotated 90°, or any angle, in the yaw direction and positioned to alter the direction of thrust such that the flying wing 10 flies in a direction parallel to a longitudinal axis such that the front longitudinal region 26 faces the direction of travel and the back longitudinal region 28 may be at the center of the trailing edge of the lifting body 12.

In this embodiment, the two jet engines 22 may be mounted on the propulsion element 14. However, other propulsion mechanisms, for example rocket engines, may optionally be used to provide thrust. The propulsion element 14 in this embodiment may have a circular platform. Optionally, the propulsion element 14 may have the shape of a ring, an ellipse, a polygon or other shape. Optionally, more than one propulsion element 14 may be mounted on the lifting body 12, each supporting one or more engines. The propulsion element 14 may also optionally include one or more vertical stabilizers.

The propulsion element 14 may be mounted at any location, for example in the center, of the upper surface of the lifting body 12 to generate sufficient longitudinal stability margin by adjusting the location of center of gravity. The propulsion element 14 may optionally be mounted on the lower surface of the lifting body 12 or the lifting body 12 may have one or more propulsion elements 14 on both its upper and lower surfaces. The propulsion element 14 may also be optionally mounted on tracks that allow the propulsion element 14 to rotate and to move to a different location on the lifting body 12. Additional propulsion elements 14 may also optionally be used.

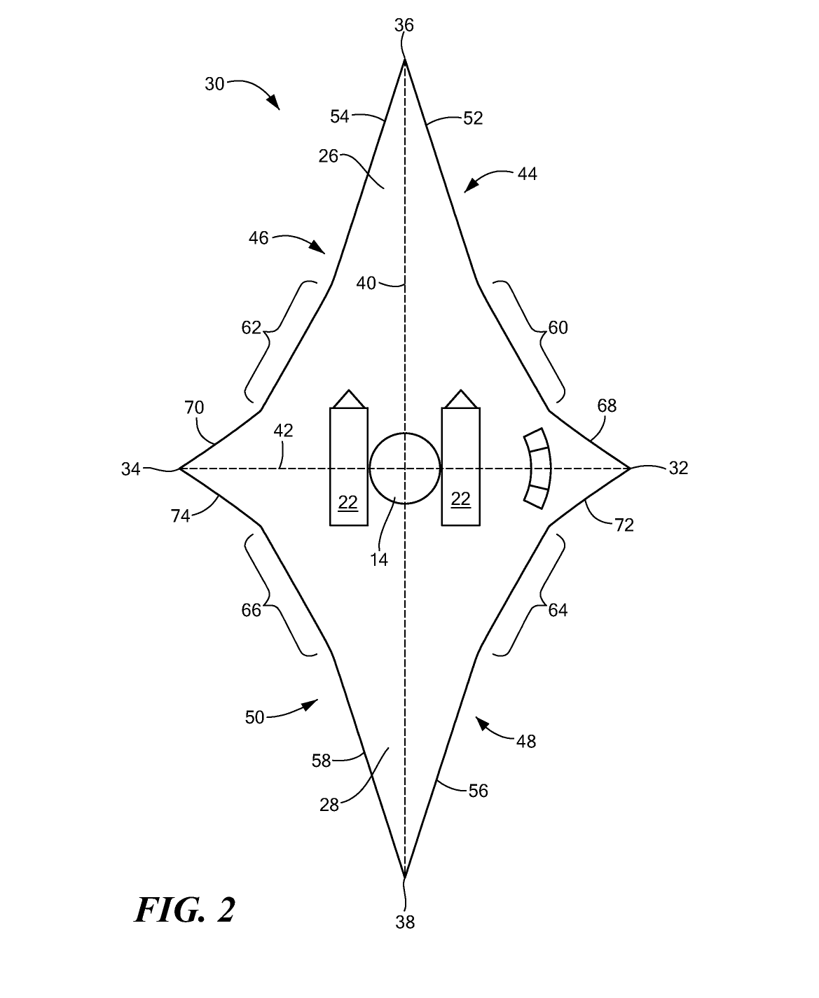

Now referring to FIG. 2, the planform 30 of the flying wing 10 of FIG. 1 having the lifting body 12 rotated 90°. As used herein, “planform” refers to the image of an aircraft viewed from above. The distance from front transverse tip 32 to back transverse tip 34 is the width of the lifting body 12 and is substantially less than the length of the lifting body 12, measured from the front longitudinal tip 36 to the back longitudinal tip 38. In this embodiment, the length may be approximately 40 meters, but may optionally be longer or shorter, depending in part on the mission requirements.

Lifting body 12 has double bilateral symmetry. That is, planform 30 is bilaterally symmetric across both longitudinal axis 40 and transverse axis 42. The flying wing 10 tapers toward the front longitudinal tip 36 and the back longitudinal tip 38 such that the flying wing 10 has a high sweep angle during flight in a direction parallel to the longitudinal axis. Conversely, when the flying wing 10 travels in a direction parallel to the transverse axis, it has a low sweep angle. As used herein, “sweep angle” refers to the angle between the leading edge of the wing and a line perpendicular to the direction of flight.

The flying wing 10 has a high aspect ratio when flown in a direction parallel to the transverse axis 42, and a low aspect ratio when flown in a direction parallel to the longitudinal axis 40. As used herein, “aspect ratio” refers to the square of the wingspan divided by the planform area, AR=b²/S. Because the entire lifting body 12 acts as an airfoil wing, the aspect ratio during flight parallel to the longitudinal axis 40 is equal to square of the width, the distance between the front transverse tip 32 and the back transverse tip 34, divided by the planform area. The aspect ratio during flight parallel to the transverse axis 42 is equal to the square of the width, the distance between the front longitudinal tip 36 and the back longitudinal tip 38, divided by the same planform area as flying in the direction of the longitudinal axis.

When flying in a direction parallel to the longitudinal axis 40, the front longitudinal region 26 may be positioned at the front of the flying wing 10 and the back longitudinal region 28 may be positioned at the back of the flying wing 10. In this configuration, the leading edge of the planform 30 may include the right edge 44 and the left leading edge 46, both having a high sweep angle when the flying wing is flown in parallel to the longitudinal axis. In this configuration, the trailing edge of the planform 30 includes the right edge 48 and the left edge 50. The high sweep angle may reduce wave drag and increase efficiency at supersonic speeds. Generally the sweep angle of the edges 44 and 46 during longitudinal flight may be between 40° and 88°, and may be about 60°.

Optionally, leading and trailing edges of a planform may vary along the length of the leading and trailing edges, as they do in planform 30. In planform 30, the sweep angle may be greatest at the front longitudinal region 26, where the longitudinal right edge 52 and the longitudinal left edge 54 may have sweep angles of generally about 60° or greater, and may be about 80°.

The back longitudinal region 28, being symmetrical with the front longitudinal region 26, may include the negatively swept back right edge 56 and the back left edge 58. These very high sweep angle regions may create air effects similar to the effects resulting from leading air extensions or strakes as incorporated in various supersonic aircraft, for example the F/A-18 Hornet. This high sweep angle in the longitudinal direction may reduce wave drag and increase fuel efficiency during supersonic flight in a direction parallel to the longitudinal axis.

The right central edge 60 and the left central edge 62 may be part of the leading edge when the flying wing 10 flies in a direction parallel to the longitudinal axis. This may provide a sweep angle of about 60°, and may be less than the sweep angle of the front longitudinal region 26. The Corresponding right central edge 64 and the corresponding left central edge 66 may have high negative sweep angles due to their symmetry with the right central edge 60 and the left central edge 62, respectively.

The front transverse region 18 and the back transverse region 24 may include the longitudinal edge 68 and the longitudinal edge 70, respectively, that may each have sweep angles of about 45°, and may be less than the sweep angle of the right central edge 60 and the left central edge 62. Likewise, the front transverse edge 72 and the back transverse edge 74 are mirror images of corresponding front transverse edge 68 and back transverse edge 70.

When the flying wing 10 travels in a direction parallel to the transverse axis 42, the right edge 48 become the right leading edge, the right edge 44 becomes the left leading edge, the left edge 46 becomes the left trailing edge and the left edge 50 becomes the right trailing edge. In this configuration, the sweep angles of the edges 44 and 48 are equal to the complimentary angles of their sweep angles in the configuration for longitudinal flight. Thus, edge 52 of the front longitudinal region, having a longitudinal sweep angle of about 60° or more, has a transverse sweep angle of about 30° or less. The edge 56 of back longitudinal region 28, being symmetric, also has a transverse sweep angle of 30° or less. Edges 68 and 72 of the front transverse region are about 45°, and the central edges 60 and 64 are between about 30°. Therefore, during flight in a direction parallel to the transverse axis, the flying wing 10 has a low sweep angle.

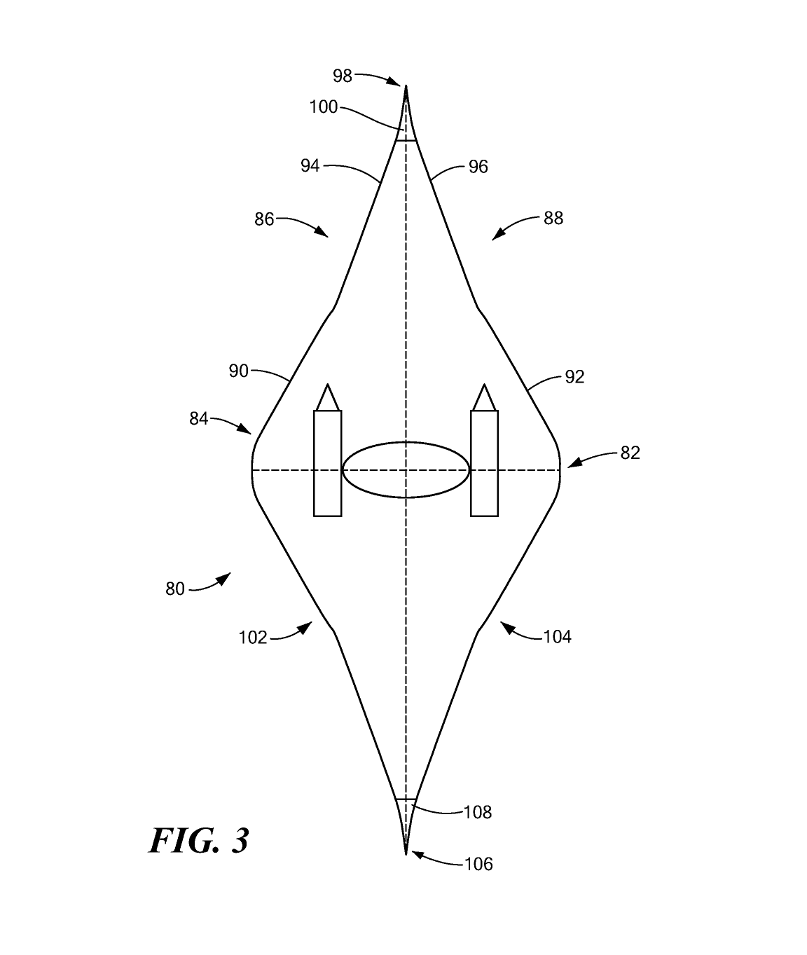

Referring now to FIG. 3, an alternative planform 80 has a blunted front transverse region 82 and a blunted back transverse region 84, different from the pointed front transverse region 18 and back transverse region 24 shown in FIGS. 1 and 2. The Planform 80 also has a left edge 86 and a right edges 88 that have a left central edge 90 and a right central edge 92, both having sweep angles between 45° and 60° during flight parallel to a transverse axis. The left front longitudinal edge 94 and the right front longitudinal edge 96 each may have a sweep angle of about 60°. The front longitudinal tip 98 may have a very high sweep angle of about 70° or greater, and may be about 80°. The front longitudinal tip 98 may be pivotably attached at a pivot point 100.

The left edge 102 and the right edge 104 are mirror images of the left edge 86 and the right edge 88. The back longitudinal tip 106 may have a sweep angle of about 70° or greater and may be pivotably attached at pivot point 108.

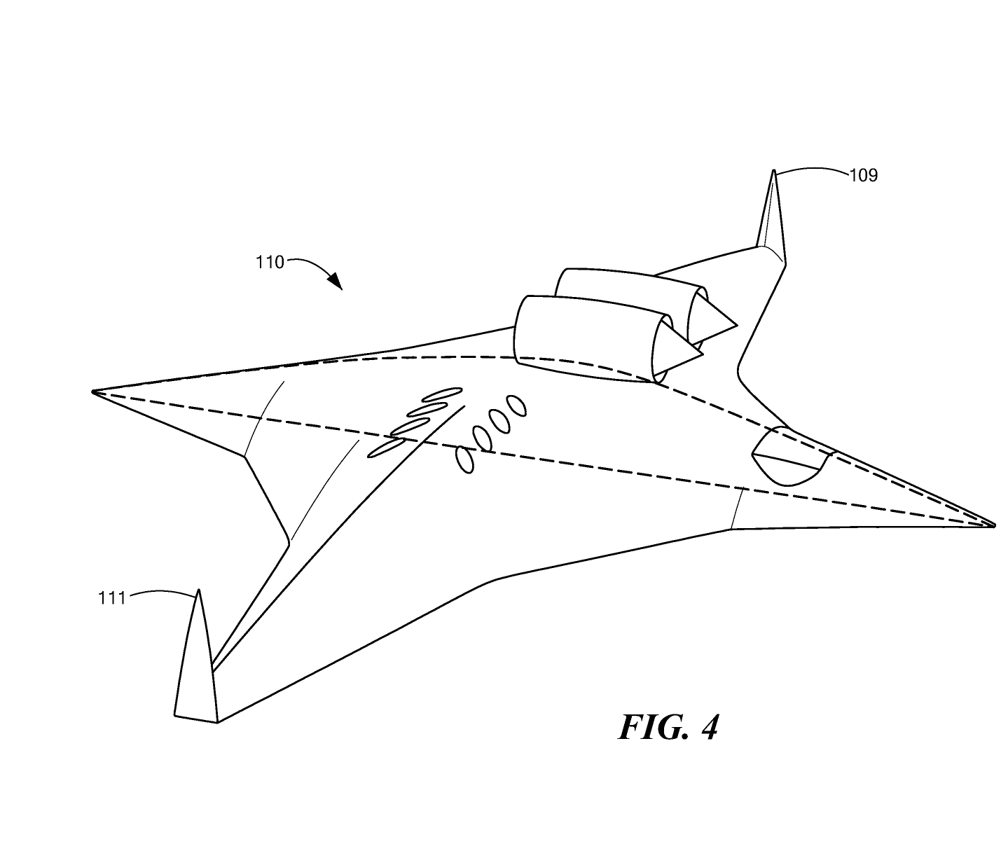

Referring now to FIG. 4, during flight parallel to a transverse axis, the front longitudinal tip 109 and the back longitudinal tip 111 may pivot upward such that they are substantially vertical, approximately 90° relative to the flying wing 110. In this embodiment, the front longitudinal tip 109 and the back longitudinal tip 111 may be pointed. Optionally, the front longitudinal tip 109 and the back longitudinal tip 111 may be rounded, blunted or squared off and may also optionally fold downward, or both. Allowing the front longitudinal tip 106 and the back longitudinal tip 108 to pivot to a vertical position may provide stability during subsonic flight.

Alternative planforms may be provided in accordance with the invention. The lengths of planforms may be substantially greater than the widths such that during flight parallel to a longitudinal axis the planform may have an aspect ratio between 0.1 and 5 and during flight parallel to a transverse axis the planform may have an aspect ratio between 1 and 20.

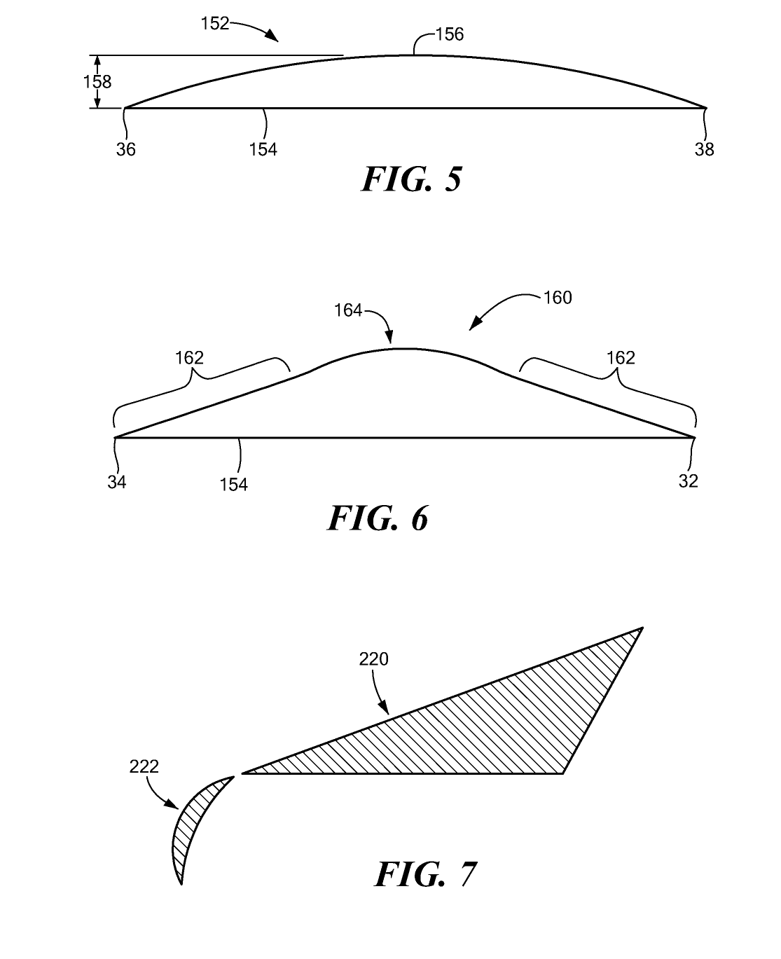

Referring now to FIG. 5, the longitudinal cross-section of the flying wing 10 shows the supersonic airfoil 152 at the centerline, i.e. at the longitudinal plane 40 in FIG. 2. The airfoil 152 may have an isentropic compression lower surface 154 which may be completely flat. As used herein, “isentropic” refers to a compression surface generating very weak or no shock waves. At a 0° angle of attack, a flat surface may be the most isentropic surface. This isentropic compression lower surface 154 may minimize the sonic boom, which may be as low as 0.3 psf. on the ground below the flying wing 10. As used herein, “angle of attack” refers to the angle between an airfoil and the direction of flight. Optionally, the lower surface 154 may be slightly curved, and may include a slight negative camber, such that the flying wing 10 may have an isentropic compression lower surface when at an angle of attack slightly above 0°, for example at a 2° angle of attack. As used herein the term “camber” refers to the curvature of the airfoil.

The upper surface 156 may be curved, having a camber that gives it a height 158 and may contribute to providing lift. The three dimensional shape of the aircraft, having a flat, isentropic compression lower surface 154 and upper camber creating a curved upper surface 156 and pointed longitudinal tips 36 and 38 may give the flying wing 10 a positive lift to drag ratio at a 0° angle of attack. In this embodiment, the upper surface 156 may have a constant curvature and may be defined by a single radius of curvature. The upper surface 156 may optionally be substantially flat in the center or may have varying degrees of curvature across the length.

Referring now to FIG. 6, the transverse cross section of the aircraft 10 shows the subsonic airfoil 160. The lower surface 154 may be flat when viewed from this direction also. The upper surface of the subsonic airfoil 160 may have a convex curvature similar to the camber of the supersonic airfoil 152. The subsonic airfoil 160, however, may include an outer region 162 and a central region 164. The outer region 162 may have a slight curvature or may be substantially straight from the transverse edges 32 and 34 up to the central region 164. The central region 164 may have a more pronounced curvature, raising it to accommodate a passenger, storage or other compartment or other internal features. The subsonic airfoil 160 may be thicker, having more camber than the relatively thin airfoil 152 used during supersonic flight. Thus, the flying wing 10 may have a relatively thin supersonic airfoil shown in FIG. 5 and a relatively thick subsonic airfoil shown in FIG. 6.

All of the airfoil shown in FIGS. 5 and 6 has an isentropic compression (flat at 0° angle of attack) lower surface. Flat lower surfaces may be isentropic at a 0° angle of attack and may produce a very weak or no downward shockwave. Optionally, the lower surface may be cambered, having a slightly curved surface, either concave or convex, to provide greater lift and/or to minimize the shock wave and associated sonic boom at a certain angle of attack.

The leading and trailing edges of airfoils in the FIGS. 1-6 are depicted as being substantially sharp edges. Supersonic airfoils may generally include sharp leading and trailing edges to improve performance at high speed. Subsonic airfoils may perform better when utilizing a blunted leading edge. In addition, the supersonic airfoil may optionally utilize slightly blunted leading edges. A blunted leading or trailing edge may provide air affects over the surface of the flying wing that increase the critical angle. As used herein the “critical angle” is the angle of attack at which an aircraft stalls. A sharp leading edge typically decreases the critical angle of an airfoil, while a blunt leading edge typically increases the critical angle.

Referring now to FIG. 7, an edge of an airfoil 220 may house a slat 222. The slat 222 may be extended from a leading edge to create a blunt edge. This may provide more lift and/or increase the critical angle of attack and/or increase the optimal angle. The slat 222 is shown extending from an airfoil edge 220 in a downward direction. The slat 222 may generally be included on any edges of a flying wing used as leading edges during flight in either direction. For example, the edges 44, 46 and 48 shown in FIG. 2 all serve as leading edges and may include slats. The slats may optionally be included only in edges that serve as leading edges during subsonic flight in the transverse direction, for example edges 44 and 48 in FIG. 2, or may optionally also be included in leading edges during supersonic flight, for example edge 46 in FIG. 2. When the aerodynamic affects caused by the slat are desired, it may be extended as shown in FIG. 7. Otherwise, the slat 222 may be housed inside the airfoil edge 220.

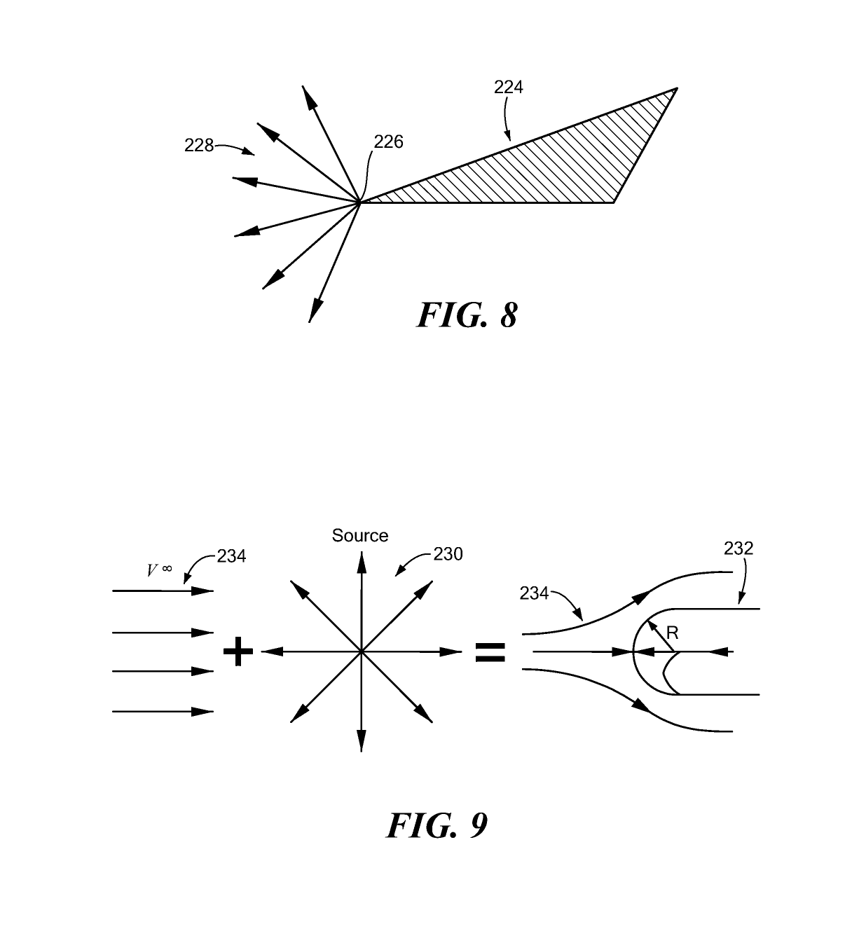

Referring now to FIG. 8, an alternative method of providing bluntness to an airfoil edge 224 uses a radial air ejector 226. Radial air ejector 226 may project high pressure airflow radially in multiple directions 228 from a leading edge 224. As shown in FIG. 9, a radial airflow 230 may form a blunt edge 232 when it encounters a unidirectional airflow 234. The amount of bluntness may be adjusted by adjusting the amount of radial airflow ejected from the radial air flow ejector 226. This method of creating a virtual blunt edge on an airfoil may require fewer moving parts and may add less weight to the overall design, and may thereby increase efficiency.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An aircraft comprising:
a lifting body defining a longitudinal axis and a transverse axis;
a propulsion element rotatably coupled to the lifting body, wherein during flight the lifting body is rotatable between a first yaw position substantially parallel to the longitudinal axis and a second yaw position substantially parallel to the transverse axis.

2. The aircraft of claim 1, wherein the lifting body is bilaterally symmetric across a longitudinal plane and bilaterally symmetric across a transverse plane; and
wherein the lifting body has a substantially isentropic compression bottom surface.

3. The aircraft of claim 2, wherein the substantially isentropic compression bottom surface is flat.

4. The aircraft of claim 1, further comprising a front longitudinal region having a sweep angle greater than 40° during flight parallel to the longitudinal axis and a back longitudinal region having a sweep angle greater than 40° during flight parallel to the longitudinal axis.

5. The aircraft of claim 1, further comprising a front longitudinal tip and a back longitudinal tip, each pivotably coupled to the lifting body so that they may pivot to approximately perpendicular to the isentropic compression bottom surface during flight parallel to the transverse axis.

6. The aircraft of claim 1, further comprising a front transverse region having a sweep angle greater than 10° during flight parallel to the transverse axis and a back transverse region having a sweep angle greater than 10° during flight parallel to the transverse axis.

7. The aircraft of claim 1, further comprising a front transverse region having a sweep angle less than 80° during flight parallel to the transverse axis and a back transverse region having a sweep angle less than 80° during flight parallel to the transverse axis.

8. The aircraft of claim 1, further comprising slats extendable from the lifting body.

9. The aircraft of claim 1, further comprising radial air ejectors in the lifting body.

10. The aircraft of claim 1, wherein the propulsion element comprises a platform having at least one engine.

11. The aircraft of claim 1, wherein the propulsion element is rotatably coupled to an upper surface of the lifting body.

12. The aircraft of claim 1, wherein the lifting body is substantially diamond-shaped.

13. The aircraft of claim 11, wherein the upper surface is curved.

14. A aircraft comprising:
a lifting body having bilateral symmetry across a longitudinal plane and bilateral symmetry across a transverse plane;
a substantially isentropic compression bottom surface;
an upper surface;
a propulsion element rotatably attached to the upper surface;
one or more engines mounted on the propulsion element; and
a front longitudinal tip and a back longitudinal tip, each pivotably coupled to the lifting body such that they may pivot to approximately perpendicular to the isentropic compression bottom surface during flight in the transverse direction;
wherein the lifting body has a sweep angle of at least 20° and an aspect ratio of less than 5 during flight parallel to a longitudinal axis; and
wherein the lifting body has a sweep angle less than 80° and an aspect ratio of at least 1 during flight parallel to a transverse axis.

15. The aircraft of claim 14, further comprising slats extendable from the lifting body.

16. The aircraft of claim 14, further comprising radial air ejectors in the lifting body.

17. The aircraft of claim 14, further the propulsion element further comprises one or more vertical stabilizers.

18. A method for subsonic and supersonic flight with reduced sonic boom generation comprising:
providing a lifting body with a larger aspect ratio in a transverse direction than the aspect ratio in a longitudinal direction;
propelling the lifting body in the transverse direction during subsonic flight; and
propelling the lifting body in the longitudinal direction during supersonic flight.

19. The method of claim 18, further comprising pivoting two longitudinal tips so that they are approximately perpendicular to the lifting body when propelled in the transverse direction.

20. The method of claim 18, wherein the propulsion is supplied by one or more engines on a rotatable propulsion element.
